(19) United States
(12) Patent Application Publication
(10) Pub. No.: US 2026/0316288 A1
(43) Pub. Date: Oct. 15, 2026

(54) Method and Control System for Detecting Contamination on an End Effector of a Robotic Manipulator

(71) Applicant: Ocado Innovation Limited, Hatfield, Hertfordshire (GB)

(72) Inventor: Marco PALADINI, London (GB)

(21) Appl. No.: 19/700,433

(22) Filed: Jun. 8, 2026

Related U.S. Application Data
(63) Continuation of application No. PCT/EP2024/085120, filed on Dec. 6, 2024.

(30) Foreign Application Priority Data
Dec. 8, 2023 (GB) 2318789.1

(51) Int. Cl. B25J 9/16; B25J 19/00

(52) U.S. Cl. CPC B25J 9/1697; B25J 9/161; B25J 19/0058

(57) ABSTRACT

A method for detecting contamination on an end effector of a robotic manipulator arranged to manipulate items. The method involves obtaining image data representative of an image of the end effector captured by a camera after a pick-and-place operation by the robotic manipulator. The image data is processed with a neural network to determine whether the end effector is contaminated. In response to a determination that the end effector is contaminated, a signal indicative of the end effector being in a contaminated state is generated.

### RELATED APPLICATIONS

This application is a continuation application of International Patent Application No. PCT/EP 2024/085120 filed 6 Dec. 2024 and entitled “Method and Control System for Detecting Contamination on an End Effector of a Robotic Manipulator,” which claims priority to UK Patent Application No. GB 2318789.1 filed 8 Dec. 2023 and entitled “Method and Control System for Detecting Contamination on an End Effector of a Robotic Manipulator”; the entire contents of both of which applications are incorporated herein by reference.

### TECHNICAL FIELD

The present disclosure relates to robotic control systems, specifically systems and methods for use in pick-and-place operations.

### BACKGROUND

Robotic systems are used in various industries, automating tasks that range from manufacturing and assembly to healthcare and logistics. The effectiveness of these robots is dependent on the functionality of their end effectors (or “grippers”). A robot gripper serves as the interface between the robot and the objects it manipulates, and its efficiency can affect the overall success of automated processes.

One significant challenge that robotic systems face is the potential contamination of their grippers. Contamination occurs when unwanted substances, particles, or materials adhere to or accumulate on the surfaces of the gripper. This problem can manifest in diverse operational environments and has implications for both the performance of the robotic system and the integrity of the objects being handled. For example, the accumulation of dust, debris, or foreign substances on the surfaces of the gripper may lead to reduced grip strength, imprecise manipulation, or even malfunction. In industries where precision and reliability are paramount, such as electronics manufacturing or medical device assembly, the impact on operational efficiency can be particularly significant.

Contamination can also pose a direct risk to the quality and integrity of the objects being handled by the robot. In industries like food production and handling, pharmaceuticals, or cleanroom manufacturing, maintaining a contamination-free environment can be important in ensuring product quality and compliance with regulatory standards. Any introduction of foreign particles through a contaminated gripper could lead to defects, product recalls, or compromised safety.

Addressing contamination in robot grippers typically involves proactive maintenance measures. Regular cleaning and inspection may be performed to mitigate the risk of accumulation. However, in certain environments or applications, such as those involving hazardous materials or extreme conditions, maintenance tasks may be challenging or pose additional safety concerns for human operators. In some applications, such as grocery handling, there is also a risk of immediate contamination by leakage (e.g. due to packaging that is faulty or damaged during the handling process).

It is against this background that the present systems and methods were devised for advanced detection of gripper contamination and automated cleaning processes.

### SUMMARY

There is provided a method for detecting contamination on an end effector of a robotic manipulator arranged to manipulate items. The method comprises: obtaining image data representative of an image of the end effector captured by a camera after a pick-and-place operation by the robotic manipulator; processing the image data with a neural network to determine whether the end effector is contaminated; and generating, in response to a determination that the end effector is contaminated, a signal indicative of the end effector being in a contaminated state.

In a related aspect, there is provided a computer program comprising instructions which, when the program is executed by a computer, cause the computer to carry out the provided method. In a further related aspect, there is provided a computer-readable data carrier having stored thereon the computer program.

In a related aspect, there is provided a control system for a robotic manipulator, wherein the controller is configured to perform the provided method.

In a related aspect, there is provided a pick-and-place robot system comprising the aforementioned control system and robotic manipulator for picking and placing an object.

In a related aspect, there is provided a storage system comprising a plurality of containers for storing items, a load-handling device for transporting a given container of the plurality of containers, and the aforementioned pick-and-place robot system arranged to pick-and-place one or more items from or into the given container.

### BRIEF DESCRIPTION OF THE DRAWINGS

Embodiments will now be described by way of example only with reference to the accompanying drawings, in which like reference numbers designate the same or corresponding parts, and in which:

FIG. 1 is a schematic diagram of a pick-and-place robot system according to an embodiment;

FIGS. 2A and 2B are schematic side views of a pick-and-place robot system according to embodiments;

FIG. 3 is a schematic perspective view of a pick-and-place robot system according to an embodiment;

FIG. 4 is a schematic perspective view of a pick-and-place robot system located on a grid structure according to an embodiment;

FIG. 5A is a schematic perspective diagram of a storage system showing load handling devices operative on a grid structure;

FIG. 5B is a schematic perspective view of a load handling device showing the lifting mechanism gripping a container from above;

FIG. 5C is a schematic perspective cutaway of the load handling device of FIG. 5B showing the container receiving space of the load handling device and how it accommodates the container in use;

FIG. 6 is a schematic diagram of a neural network; and

FIG. 7 is a flowchart depicting a method for controlling a robotic manipulator according to an embodiment.

In the drawings, like features are denoted by like reference numerals where appropriate, e.g. incremented by multiples of 10 or 100 according to the Figure number.

### DETAILED DESCRIPTION

In the following description, some specific details are included in the following description to provide a thorough understanding of various disclosed embodiments. However, one skilled in the relevant art will recognise that embodiments may be practised without one or more of these specific details or with other methods, components, materials, etc. In some instances, well-known structures associated with gripper assemblies and/or robotic manipulators (such as processors, sensors, storage devices, network interfaces, workpieces, tensile members, fasteners, electrical connectors, mixers, and the like) are not shown or described in detail to avoid unnecessarily obscuring descriptions of the disclosed embodiments.

Reference throughout this specification to “one”, “an”, or “another” applied to “embodiment” or “example”, means that a particular referent feature, structure, or characteristic described in connection with the embodiment, example, or implementation is included in at least one embodiment, example, or implementation. Thus, the appearances of the phrase “in one embodiment” or the like in various places throughout this specification do not necessarily refer to the same embodiment. Furthermore, the particular features, structures, or characteristics may be combined in any suitable manner in one or more embodiments, examples, or implementations.

It should be noted that, as used in this specification and the appended claims, the used forms “a”, “an”, and “the” include plural referents unless the content clearly dictates otherwise. It should also be noted that the term “or” is generally employed in its sense including “and/or” unless the content clearly dictates otherwise.

The language “movement in the n-direction” (and related wording), where n is one of x, y and z, is intended to mean movement substantially along or parallel to the n-axis, in either direction (i.e. towards the positive end of the n-axis or towards the negative end of the n-axis). In this document, the word “connect” and its derivatives are intended to include the possibilities of direct and indirection connection. For example, “x is connected to y” is intended to include the possibility that x is directly connected to y, with no intervening components, and the possibility that x is indirectly connected to y, with one or more intervening components. Where a direct connection is intended, the words “directly connected”, “direct connection” or similar will be used. Similarly, the word “support” and its derivatives are intended to include the possibilities of direct and indirect contact. For example, “x supports y” is intended to include the possibility that x directly supports and directly contacts y, with no intervening components, and the possibility that x indirectly supports y, with one or more intervening components contacting x and/or y. The word “mount” and its derivatives are intended to include the possibility of direct and indirect mounting. For example, “x is mounted on y” is intended to include the possibility that x is directly mounted on y, with no intervening components, and the possibility that x is indirectly mounted on y, with one or more intervening components. In this document, the word “comprise” and its variants like “comprises” and “comprising” are intended to have an inclusive rather than an exclusive meaning. For example, “x comprises y” is intended to include the possibilities that x includes one and only one y, multiple y's, or one or more y's and one or more other elements. Where an exclusive meaning is intended, the language “x is composed of y” will be used, meaning that x includes only y and nothing else. In this document, a “controller” or “control system” is intended to include any hardware which is suitable for controlling (e.g. providing instructions to) one or more other components: for example, a processor equipped with one or more memories and appropriate software to process data relating to a component or components and send appropriate instructions to the component(s) to enable the component(s) to perform its/their intended function(s).

The term “pose” used throughout this specification represents the position and orientation of a given object in space. For example, a six-dimensional (6D) pose of the object includes respective values in three translational dimensions (e.g. corresponding to a position) and three rotational dimensions (e.g. corresponding to an orientation) of the object.

In general terms, this description introduces systems and methods to automatically check whether a robot gripper has become contaminated during its pick-and-place operations. This is done using image data obtained via a camera, e.g. one or more images of the end effector captured after a given pick-and-place of an object by the robot. For example, anomaly detection is performed on the image data using a neural network to determine whether there is contamination present on the gripper surface. A positive determination triggers a contaminated state for the gripper/robot. The contaminated state is signalled for resolution by cleaning or replacing the gripper on the robot (e.g. manually, automatically, and/or via teleoperation). For example, an automated tool exchange may be triggered by the signalled contaminated state in which the robot manipulator swaps the contaminated gripper for a different one, e.g. stored in a tool exchange area proximate to the robot. In some cases, only a part of the end effector is replaced (manually or automatically) in response to the signal indicative of a contaminated gripper. For example, one or more finger elements of a jaw gripper, or a suction cup (without a connecting stem part) of a vacuum gripper is replaced to resolve the contaminated state of the gripper.

The automatic contamination check is employed (e.g. as a microservice) to reduce the possibility of contaminating other objects being manipulated by the robot. For example, a gripper in a contaminated state may go on to spread the contaminant onto objects in later pick-and-place operations. In the context of an automated storage and retrieval system (ASRS), multiple containers of objects may become contaminated with the contaminant by the robot picking and/or placing objects from/into the said containers using the contaminated gripper.

Overall, the present system and methods at least reduce, or completely avoid, the need to install dedicated sensors and/or manual processes for checking the end effectors of robot systems for contamination.

Instead, the present systems and methods utilise a camera, which may already be available to the robotic manipulator for other tasks (e.g. analysing an object during placement thereof) to detect contaminated end effectors. For example, an image of the end effector captured by the camera is automatically processed to check whether the end effector is contaminated between picks.

### General Robotic System

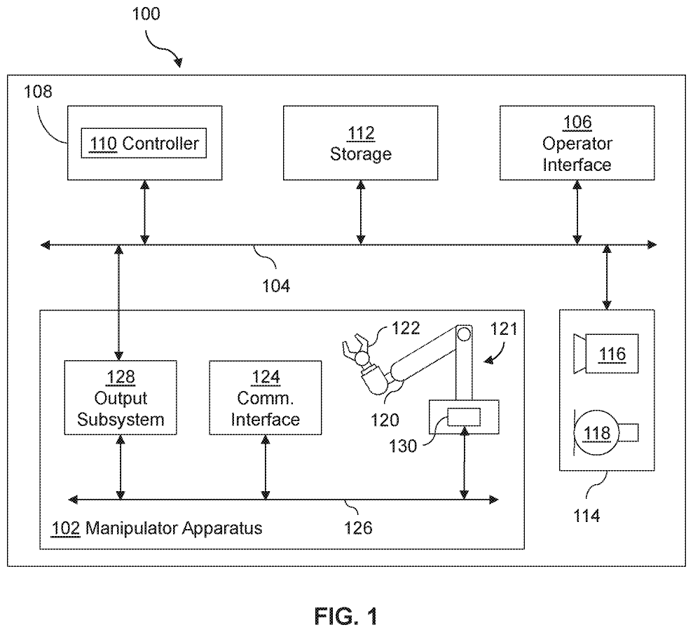

FIG. 1 illustrates an example of a robotic system 100 that may be adapted for use with the present assemblies, devices, and methods. The robotic system 100 may form part of an online retail operation, such as an online grocery retail operation. Still, it may also be applied to any other operation requiring the packing of items. For example, the robotic system 100 may also be adapted for picking or sorting articles, e.g. as a robotic picking/packing system sometimes referred to as a “pick-and-place robot”.

The robotic system 100 includes a manipulator apparatus 102 comprising a robotic manipulator 121. The manipulator 121 is an electro-mechanical machine comprising one or more appendages, such as a robotic arm 120, and an end effector 122 mounted on an end of the robotic arm 120. The end effector 122 is a device configured to interact with the environment in order to perform tasks, including, for example, gripping, grasping, releasably engaging or otherwise interacting with an item. Examples of the end effector 122 include a jaw gripper, a finger gripper, a magnetic or electromagnetic gripper, a Bernoulli gripper, a vacuum suction cup, an electrostatic gripper, a van der Waals gripper, a capillary gripper, a cryogenic gripper, an ultrasonic gripper, and a laser gripper.

The robotic manipulator 121 can grasp and manipulate an object. For example, in the case of a pick-and-place application, the robotic manipulator 121 is configured to pick an item from a first location and place the item in a second location.

The manipulator apparatus 102 is communicatively coupled via a communication interface 104 to other components of the robotic packing system 100, e.g. one or more optional operator interfaces 106 from which an observer may observe or monitor system 100 and the manipulator apparatus 102. The operator interfaces 106 may include a WIMP interface and an output display of explanatory text or a dynamic representation of the manipulator apparatus 102 in a context or scenario. For example, the dynamic representation of the manipulator apparatus 102 may include a video feed, for instance, a computer-generated animation. Examples of suitable communication interface 104 include a wire-based network or communication interface, an optical-based network or communication interface, a wireless network or communication interface, or a combination of wired, optical, and/or wireless networks or communication interfaces.

The example robotic system 100 also includes a control system 108, including at least one controller 110 communicatively coupled to the manipulator apparatus 102 and any other components of the robotic system 100 via the communication interface 104. The controller 110 comprises a control unit or computational device having one or more electronic processors. Embedded within the one or more processors is computer software comprising a set of control instructions provided as processor-executable data that, when executed, cause the controller 110 to issue actuation commands or control signals to the manipulator system 102. For example, the actuation commands or control signals cause the manipulator 121 to carry out various methods and actions, such as identifying and manipulating items.

The one or more electronic processors may include at least one logic processing unit, such as one or more microprocessors, central processing units (CPUs), digital signal processors (DSPs), graphics processing units (GPUs), application-specific integrated circuits (ASICs), programmable gate arrays (PGAs), programmed logic units (PLUs), or the like. In some implementations, the controller 110 is a smaller processor-based device like a mobile phone, single-board computer, embedded computer, or the like, which may be termed or referred to interchangeably as a computer, server, or analyser. The set of control instructions may also be provided as processor-executable data associated with the operation of the system 100 and manipulator apparatus 102 included in a non-transitory computer-readable storage device 112, which forms part of the robotic system 100 and is accessible to the controller 110 via the communication interface 104.

In some implementations, the storage device 112 includes two or more distinct devices. The storage device 112 can, for example, include one or more volatile storage devices, e.g. random access memory (RAM), and one or more non-volatile storage devices, e.g. read-only memory (ROM), flash memory, magnetic hard disk (HDD), optical disk, solid-state disk (SSD), or the like. A person of skill in the art will appreciate storage may be implemented in a variety of ways such as a read-only memory (ROM), random access memory (RAM), hard disk drive (HDD), network drive, flash memory, digital versatile disk (DVD), any other forms of computer-and processor-readable memory or storage medium, and/or a combination thereof. Storage can be read-only or read-write as needed.

The robotic system 100 includes a sensor subsystem 114 comprising one or more sensors that detect, sense or measure conditions or states of the manipulator apparatus 102 and/or conditions in the environment or workspace in which the manipulator 121 operates and produce or provide corresponding sensor data or information. Sensor information includes environmental sensor information, representative of environmental conditions within the workspace of the manipulator 121, as well as information representative of condition or state of the manipulator apparatus 102, including the various subsystems and components thereof, and characteristics of the item to be manipulated. The acquired data may be transmitted via the communication interface 104 to the controller 110 for directing the manipulator 121 accordingly. Such information can, for example, include diagnostic sensor information that is useful in diagnosing a condition or state of the manipulator apparatus 102 or the environment in which the manipulator 121 operates.

Such sensors include, for example, one or more cameras or imagers 116 (e.g. responsive within visible and/or non-visible ranges of the electromagnetic spectrum including, for instance, infrared and ultraviolet). The one or more cameras 116 may include a depth camera, e.g. a stereo camera, to capture depth data alongside colour channel data in an imaged scene. Other sensors of the sensor subsystem 114 may include one or more of: contact sensors, force sensors, strain gages, vibration sensors, position sensors, attitude sensors, accelerometers, radars, sonars, lidars, touch sensors, pressure sensors, load cells, microphones 118, meteorological sensors, chemical sensors, or the like. In some implementations, the sensors include diagnostic sensors to monitor a condition and/or health of an on-board power source within the manipulator apparatus 102 (e.g. a battery array, ultra-capacitor array, or fuel cell array).

In some implementations, the one or more sensors comprise receivers to receive position and/or orientation information concerning the manipulator 121. For example, a global position system (GPS) receiver to receive GPS data, two more time signals for the controller 110 to create a position measurement based on data in the signals, such as time-of-flight, signal strength, or other data to effect a position measurement. Also, for example, one or more accelerometers, which may also form part of the manipulator apparatus 102, could be provided on the manipulator 121 to acquire inertial or directional data, in one, two, or three axes, regarding the movement thereof.

The robotic manipulator 121 of the system 100 may be piloted by a human operator at the operator interface 106. In a human operator-controlled (or “piloted”) mode, the human operator observes representations of sensor data, e.g. video, audio, or haptic data received from the one or more sensors of the sensor subsystem 114. The human operator then acts, conditioned by a perception of the representation of the data, and creates information or executable control instructions to direct the manipulator 121 accordingly. In the piloted mode, the manipulator apparatus 102 may execute control instructions in real-time (e.g. without added delay) as received from the operator interface 106 without taking into account other control instructions based on the sensed information.

In some implementations, the manipulator apparatus 102 operates autonomously, i.e. without a human operator creating control instructions at the operator interface 106 for directing the manipulator 121. The manipulator apparatus 102 may operate in an autonomous control mode by executing autonomous control instructions. For example, the controller 110 can use sensor data from one or more sensors of the sensor subsystem 114. The sensor data is associated with operator-generated control instructions from one or more times during which the manipulator apparatus 102 was in the piloted mode to generate autonomous control instructions for subsequent use. For example, deep learning techniques can be used to extract features from the sensor data. Thus, in the autonomous mode, the manipulator apparatus 102 can autonomously recognise features or conditions of its environment and the item to be manipulated. In response, the manipulator apparatus 102 performs one or more defined acts or tasks. For example, the manipulator apparatus 102 performs a pipeline or sequence of acts or tasks.

In some implementations, the controller 110 autonomously recognises features or conditions of the environment surrounding the manipulator 121 and one or more virtual items composited into the environment. The environment is represented by sensor data from the sensor subsystem 114. In response to being presented with the representation, the controller 110 issues control signals to the manipulator apparatus 102 to perform one or more actions or tasks.

In some instances, the manipulator apparatus 102 may be controlled autonomously at a given time while being piloted, operated, or controlled by a human operator at another time. That is, the manipulator apparatus 102 may operate under the autonomous control mode and change to operate under the piloted (i.e. non-autonomous) mode. In another mode of operation, the manipulator apparatus 102 can replay or execute control instructions previously carried out in the piloted mode. That is, the manipulator apparatus 102 can operate based on replayed pilot data without sensor data.

The manipulator apparatus 102 further includes a communication interface subsystem 124 (e.g. a network interface device) communicatively coupled to a bus 126 and which provides bi-directional communication with other components of the system 100 (e.g. the controller 110) via the communication interface 104. The communication interface subsystem 124 may be any circuitry effecting bidirectional communication of processor-readable data and processor-executable instructions, such as radios (e.g. radio or microwave frequency transmitters, receivers, transceivers) ports, and/or associated controllers. Suitable communication protocols include FTP, HTTP, Web Services, SOAP with XML, cellular (e.g. GSM, CDMA), Wi-Fi® compliant, Bluetooth® compliant, and the like.

The manipulator apparatus 102 further includes a motion subsystem 130, communicatively coupled to the robotic arm 120 and end effector 122. The motion subsystem 130 comprises one or more motors, solenoids, other actuators, linkages, drive-belts, or the like operable to cause the robotic arm 120 and/or end effector 122 to move within a range of motions in accordance with the actuation commands or control signals issued by the controller 110. The motion subsystem 130 is communicatively coupled to the controller 110 via the bus 126.

The manipulator apparatus 102 also includes an output subsystem 128 comprising one or more output devices, such as speakers, lights, or displays that enable the manipulator apparatus 102 to send signals into the workspace to communicate with, for example, an operator and/or another manipulator apparatus 102.

A person of ordinary skill in the art will appreciate the components in manipulator apparatus 102 may be varied, combined, split, omitted, or the like. In some examples, one or more of the communication interface subsystem 124, the output subsystem 128, and the motion subsystem 130 are combined. In other instances, one or more subsystems (e.g. the motion subsystem 130) are split into further subsystems.

### Pick-and-Place Robot

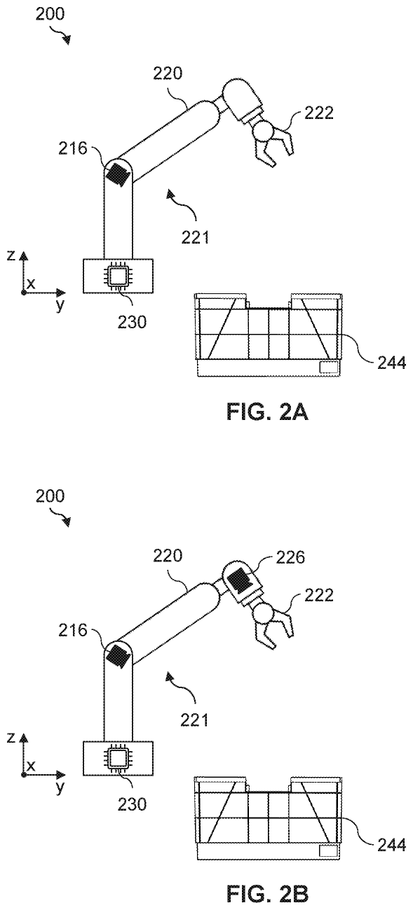

FIGS. 2A and 2B show examples of a pick-and-place robot system 200 including a robotic manipulator 221, e.g. an implementation of the robotic manipulator 121 described in previous examples. In accordance with such examples, the robotic manipulator 221 includes a robotic arm 220, an end effector 222, and a motion subsystem 230. The motion subsystem 230 is communicatively coupled to the robotic arm 220 and end effector 222 and configured to cause the robotic arm 220 and/or end effector 222 to move in accordance with actuation commands or control signals issued by a controller (not shown). The controller, e.g. controller 110 described in previous examples, is part of a manipulator apparatus with the robotic manipulator 221.

The robotic manipulator 221 is arranged to manipulate an object grasped by the end effector 222 as part of a pick-and-place operation. The general purpose of such pick-and-place operations is for the manipulator 221 to pick up objects (components, parts, or items) from one location and accurately place them in another location such, e.g. a container (or “bin” or “tote”) 244 shown in FIGS. 2A and 2B. The placement may also involve a precise and predefined orientation for the object, e.g. according to a packing scheme for placing the object into the tote 244 already having previously picked items stored therein.

A given pick-and-place operation typically includes pick, transport, and placement steps. During pick, the system 200 uses the manipulator 221 to pick up an object from a source location with the end effector 222. Additionally or alternatively to a tote 244, the source location could be a conveyor belt, a tray, a pallet, or another designated area of a storage system. Once the object is picked up, the system 200 transports it to the desired location, guided by the robotic arm 220. Finally, the system 200 then places the object at the destination location, which could be another tote, a conveyor belt, within a machine for further processing, onto a circuit board (during electronics assembly), or any other specified location.

The pick-and-place robot system 200 may be implemented as part of a storage system, such as a warehousing storage system (e.g. utilising storage such as pallet racks, shelving units, and mezzanines to store goods) or an automated storage and retrieval system (ASRS) that utilises automated machinery and computerised control systems to handle the storage and retrieval of goods. For example, the pick-and-place robot system 200 can be implemented at a picking station of the storage system, at which items are picked from one location (e.g. off a pallet or out of a tote) and placed at another location (e.g. onto a conveyor or into a tote). In some cases, the picking station is located away from the storage locations of the items in the storage system, e.g. away from the storage grid in a grid-based ASRS. Load-handling devices (or Automated Guided Vehicles, “AGVs”, or Autonomous Mobile Robots, “AMRs”) may therefore deliver and collect the stored items to/from the picking station, e.g. via one or more ports of the storage system which are linked to the picking station by chutes or the like. In other instances, the picking station is located to interact directly with a subset of storage locations in the storage system, e.g. to pick and place items between a subset of storage locations. For example, in the case of a grid-based ASRS, the picking station may be located on the grid of the ASRS for the robot arm 220 to access storage locations in the grid directly.

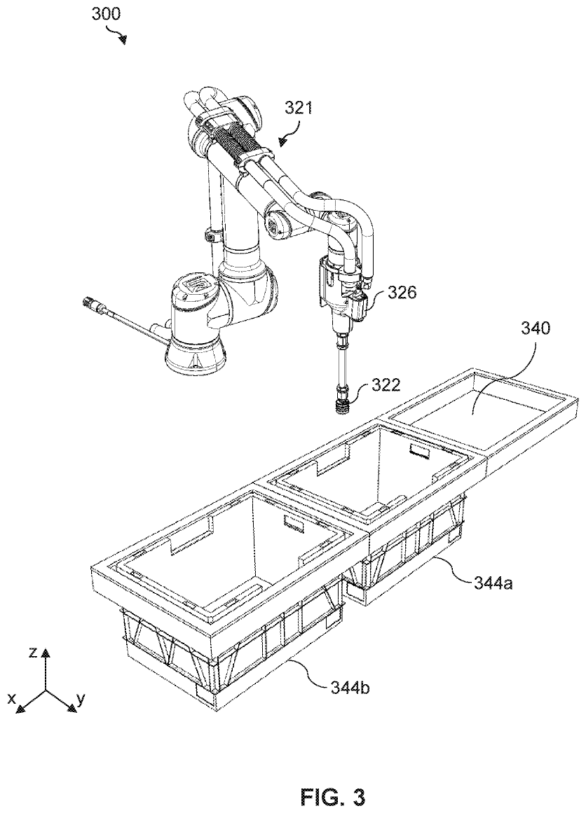

FIG. 3 shows an example of a pick station 300 employing a pick-and-place robot system, e.g. an implementation of the aforementioned pick-and-place robot system 200. The end effector 322 of the robotic manipulator 321 in this example comprises a suction cup in fluid communication with a negative pressure source, e.g. a vacuum pump (not shown). The pick station includes multiple container locations 340 for receiving containers 344 of items. Respective containers 344 can be arranged in respective container locations 340 such that the end effector 322 of the robotic manipulator 321 can interact with items stored therein. The containers 344 may be moved between the locations 340 by conveyors, load-handling devices, or other machinery. Items stored in the containers are picked from and/or placed into one or more retrieved containers 344.

In the example shown in FIG. 3, the pick-and-place robot system is arranged for the robotic manipulator 321 to pick an item stored in a first container 344a, transport the item to another container location, and place the item in a second container 344b. In examples, the first container 344a is a storage container and the second container 344b is a delivery container. For example the storage container 344a is a container which remains within the storage system and holds “eaches” of products which can be transferred from the storage container to a given delivery container. The delivery container 344b is a container that is introduced into the storage system when empty and has a number of different products loaded into it. For example, a delivery container comprises one or more bags or cartons into which products may be loaded. In some systems, the delivery containers are substantially the same size as the storage containers, while in other systems the delivery containers are slightly smaller than the storage containers such that a delivery container may be nested within a storage container.

In alternative examples, the picking station 300 has two separate sections: one section for the storage container and one for the delivery container. The arrangement of the picking station, e.g. the sections thereof, can be varied and selected as appropriate. For example, the two sections may be arranged on two sides of an area or with one section above or below the other.

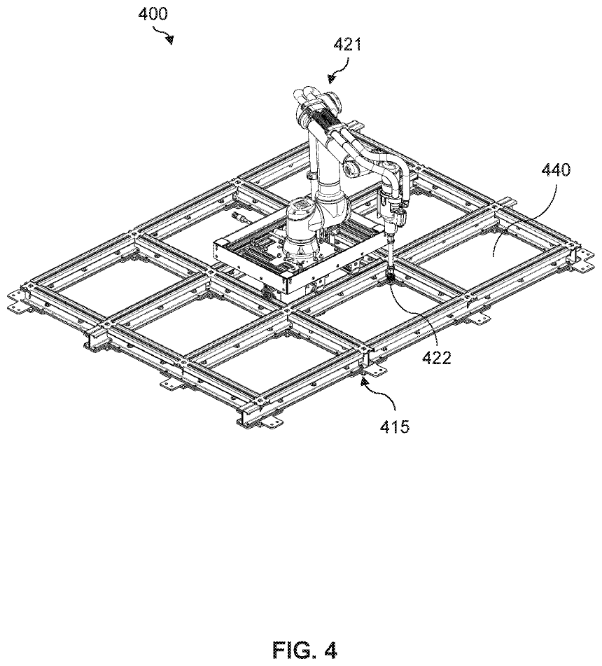

FIG. 4 shows an example of a pick-and-place robot system 400, comprising a robotic manipulator 421 as described, located on a section of grid 415 which forms, in examples, part of the storage system, e.g. the ASRS.

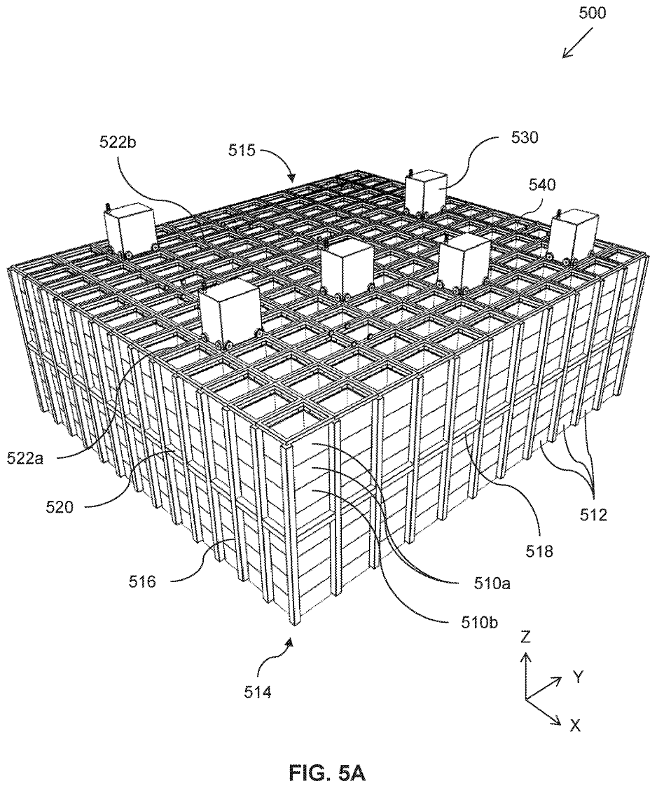

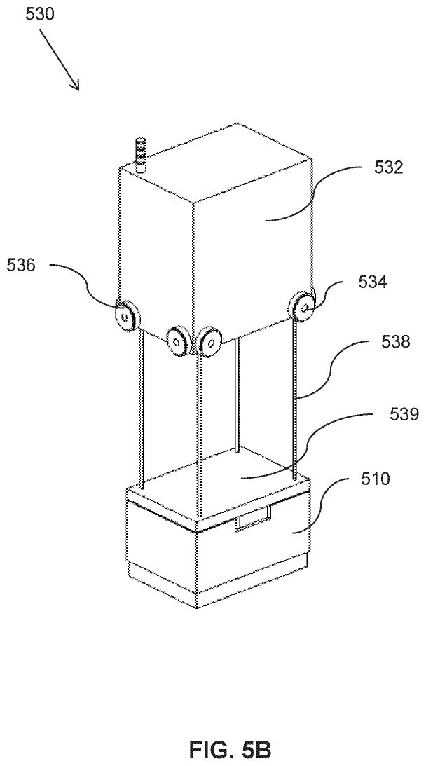

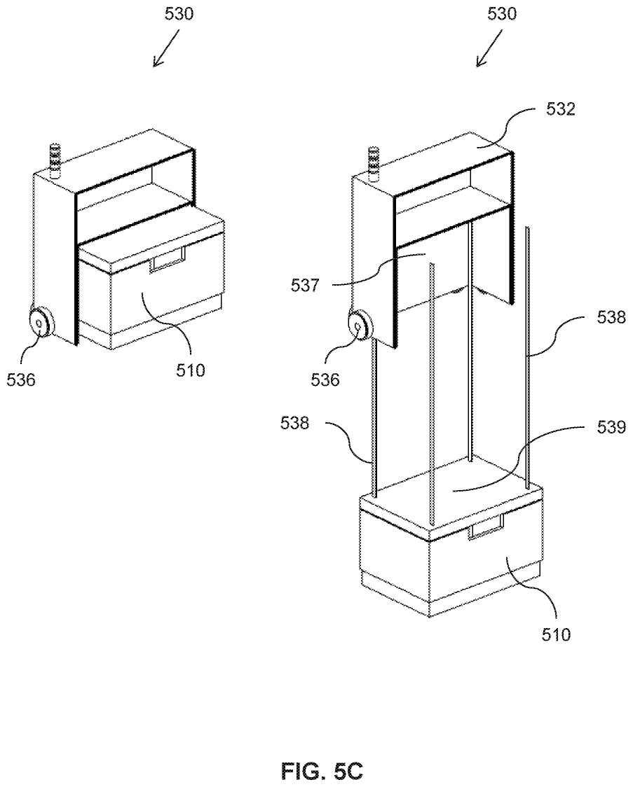

FIG. 5A is a schematic perspective view of an example ASRS 500, in which stackable containers 510 (or “bins” or “totes”) are stacked on top of one another to form stacks 512. The stacks 512 are arranged in a grid framework structure 514, e.g. in a warehousing or manufacturing environment. The grid framework structure 514 is made up of a plurality of storage columns or grid columns. Each bin 510 typically holds a plurality of product items (not shown): the product items within a bin 510 may be identical or different product types depending on the application.

The grid framework structure 514 comprises a plurality of upright members 516 that support horizontal members 518, 520. A first set of parallel horizontal grid members 518 is arranged perpendicularly to a second set of parallel horizontal members 520 in a grid pattern to form a horizontal grid structure 515 supported by the upright members 516. The members 516, 518, 520 are typically manufactured from metal. The bins 510 are stacked between the members 516, 518, 520 of the grid framework structure 514, so that the grid framework structure 514 guards against horizontal movement of the stacks 512 of bins 510 and guides the vertical movement of the bins 510.

The top level of the grid framework structure 514 comprises a grid or grid structure 515, including rails 522 arranged in a grid pattern across the top of the stacks 512. The rails or tracks 522 guide a plurality of robotic load handling devices 530 (or “retrieval robots”). A first set 522a of parallel rails 522 guides movement of the retrieval robots 530 in a first direction (e.g. an X-direction) across the top of the grid framework structure 514. A second set 522b of parallel rails 522, arranged perpendicular to the first set 522a, guides movement of the retrieval robots 530 in a second direction (e.g. a Y-direction), perpendicular to the first direction. In this way, the rails 522 allow the retrieval robots 530 to move laterally in two dimensions in the horizontal X-Y plane. A retrieval robot 530 can be moved into position above any one of the stacks 512.

An example form of robotic load handling device 530—shown in FIGS. 5A to 5C covers a single grid space 540 of the grid 515. This arrangement allows a higher density of load handlers operating on the grid 515 of the ASRS, and thus a higher throughput for a given sized storage system.

The example load handling device 530 comprises a vehicle 532, which is arranged to travel on the rails 522 of the frame structure 514. A first set of wheels 534, consisting of a pair of wheels 534 at the front of the vehicle 532 and a pair of wheels 534 at the back of the vehicle 532, is arranged to engage with two adjacent rails of the first set 522a of rails 522. Similarly, a second set of wheels 536, consisting of a pair of wheels 536 at each side of the vehicle 532, is arranged to engage with two adjacent rails of the second set 522b of rails 522. Each set of wheels 534, 536 can be lifted and lowered so that either the first set of wheels 534 or the second set of wheels 536 is engaged with the respective set of rails 522a, 522b at any one time during movement of the load handling device 530. For example, when the first set of wheels 534 is engaged with the first set of rails 522a and the second set of wheels 536 is lifted clear from the rails 522, the first set of wheels 534 can be driven, by way of a drive mechanism (not shown) housed in the vehicle 532, to move the load handling device 530 in the X-direction. To achieve movement in the Y-direction, the first set of wheels 534 is lifted clear of the rails 522, and the second set of wheels 536 is lowered into engagement with the second set 522b of rails 522. The drive mechanism can then be used to drive the second set of wheels 536 to move the load handling device 530 in the Y-direction.

The load handling device 530 is equipped with a lifting mechanism, e.g. a crane mechanism, to lift a storage container 510 from above. The lifting mechanism comprises a winch tether or cable 538 wound on a spool or reel (not shown) and a gripper device 539. The lifting mechanism shown in FIGS. 5B and 5C comprises a set of four lifting tethers 538 extending in a vertical direction. The tethers 538 are connected at or near the respective four corners of the gripper device 539, e.g. a lifting frame, for releasable connection to a storage container 510. For example, a respective tether 538 is arranged at or near each of the four corners of the lifting frame 539. The gripper device 539 is configured to releasably grip the top of a storage container 510 to lift it from a stack of containers in a storage system 500 of the type shown in FIG. 5A. For example, the lifting frame 539 may include pins (not shown) that mate with corresponding holes (not shown) in the rim that forms the top surface of bin 510, and sliding clips (not shown) that are engageable with the rim to grip the bin 510. The clips are driven to engage with the bin 510 by a suitable drive mechanism housed within the lifting frame 539, powered and controlled by signals carried through the cables 538 themselves or a separate control cable (not shown).

To remove a bin 510 from the top of a stack 512, the load handling device 530 is first moved in the X-and Y-directions to position the gripper device 539 above the stack 512. The gripper device 539 is then lowered vertically in the Z-direction to engage with the bin 510 on the top of the stack 512, as shown in FIGS. 5B and 5C. The gripper device 539 grips the bin 510, and is then pulled upwards by the cables 538, with the bin 510 attached. At the top of its vertical travel, the bin 510 is held above the rails 522 accommodated within the vehicle body 532. In this way, the load handling device 530 can be moved to a different position in the X-Y plane, carrying the bin 510 along with it, to transport the bin 510 to another location in the grid 515. On reaching the target location (e.g. another stack 512, an access point in the storage system, or a conveyor belt) the bin or container 510 can be lowered from the container receiving portion and released from the grabber device 539. The cables 538 are long enough to allow the load handling device 530 to retrieve and place bins from any level of a stack 512, e.g. including the floor level.

As shown in FIG. 5A, a plurality of identical load handling devices 530 is provided so that each load handling device 530 can operate simultaneously to increase the system's throughput. The system illustrated in FIG. 5A may include specific locations, known as ports, at which bins 510 can be transferred into or out of the system. An additional conveyor system (not shown) is associated with each port so that bins 510 transported to a port by a load handling device 530 can be transferred to another location by the conveyor system, such as a picking station (not shown). Similarly, bins 510 can be moved by the conveyor system to a port from an external location, for example, to a bin-filling station (not shown), and transported to a stack 512 by the load handling devices 530 to replenish the stock in the system.

Each load handling device 530 can lift and move one bin 510 at a time. The load handling device 530 has a container-receiving cavity or recess 537, in its lower part. The recess 537 is sized to accommodate the container 510 when lifted by the lifting mechanism 538, 539, as shown in FIG. 5C. When in the recess 537, the container 510 is lifted clear of the rails 522 beneath, so that the vehicle 532 can move laterally to a different grid location 540.

If it is necessary to retrieve a bin 510b (“target bin”) that is not located on the top of a stack 512, then the overlying bins 510a (“non-target bins”) are first be moved to allow access to the target bin 510b. This is achieved by an operation referred to hereafter as “digging”. Referring to FIG. 5A, during a digging operation, one of the load handling devices 530 lifts each non-target bin 510a sequentially from the stack 512 containing the target bin 510b and places it in a vacant position within another stack 512. The target bin 510b can then be accessed by the load handling device 530 and moved to a port for further transportation.

Each load handling device 530 is remotely operable under the control of a central computer, e.g. a master controller. Each individual bin 510 in the system is also tracked so that the appropriate bins 510 can be retrieved, transported and replaced as necessary. For example, during a digging operation, each non-target bin location is logged so that the non-target bin 510a can be tracked.

Wireless communications and networks may be used to provide the communication infrastructure from the master controller, e.g. via one or more base stations, to the one or more load handling devices 530 operative on the grid structure 515. In response to receiving instructions from the master controller, a controller in the load handling device 530 is configured to control various driving mechanisms to control the movement of the load handling device. For example, the load handling device 530 may be instructed to retrieve a container from a target storage column at a particular location on the grid structure 515. The instruction can include various movements in the X-Y plane of the grid structure 515. As previously described, once at the target storage column, the lifting mechanism 538, 539 can be operated to grip and lift the storage container 510. Once the container 510 is accommodated in the container-receiving space 537 of the load handling device 530, it is subsequently transported to another location on the grid structure 515, e.g. a “drop-off port”. At the drop-off port, the container 510 is lowered to a suitable pick station to allow retrieval of any item in the storage container. Movement of the load handling devices 530 on the grid structure 515 can also involve the load handling devices 530 being instructed to move to a charging station, usually located at the periphery of the grid structure 515.

To manoeuvre the load handling devices 530 on the grid structure 515, each of the load handling devices 530 is equipped with motors for driving the wheels 534, 536. The wheels 534, 536 may be driven via one or more belts connected to the wheels or driven individually by a motor integrated into the wheels. For a single-cell load handling device (where the footprint of the load handling device 530 occupies a single grid cell 540), and the motors for driving the wheels can be integrated into the wheels due to the limited availability of space within the vehicle body. For example, the wheels of a single-cell load handling device 530 are driven by respective hub motors. Each hub motor comprises an outer rotor with a plurality of permanent magnets arranged to rotate about a wheel hub comprising coils forming an inner stator.

The cubic ASRS described with reference to FIGS. 5A to 5C has many advantages and is suitable for a wide range of storage and retrieval operations. In particular, it allows very dense storage of products and provides a very economical way of storing a wide range of different items in the bins 510 while also allowing reasonably economical access to all of the bins 510 when required for picking.

Returning to FIG. 4, in which the pick-and-place robot system 400 according to the present disclosure is located on a section of grid 415, which may correspond to the grid 515 of the cubic ASRS 500 described with reference to FIGS. 5A to 5C, retrieval robots may travel along the two orthogonal axes of the grid 405 to deliver containers to the pick-and-place robot system 400. The pick-and-place robot system 400 thus forms an on-grid robotic picking station for the ASRS. In the schematic depiction of FIG. 4, the robotic manipulator 421 is received on a plinth connected to the grid structure 405, e.g. which is part of the framework 514 of the storage system 500, such that the robotic manipulator 421 is mounted on the storage system 500. For example, the plinth may be connected to one or more of the upright members and/or horizontal members of the storage system. In an alternative, a mount may be used to connect the robotic manipulator 421 to the framework. For example, one or more mount members may mount the robotic manipulator 421, e.g. the base of the robotic arm, to one or more members of the storage system.

The robotic manipulator 221, 321, 421 of the present pick-and-place system 200, 300, 400 may comprise one or more end effectors 222, 322, 422. For example, the robotic manipulator 221, 321, 421 may comprise more than one different type of end effector. As previously described, in the examples of FIGS. 2A and 2B, the end effector 222 comprises a jaw gripper whereas in the examples of FIGS. 3 and 4, the end effector 322, 422 comprises a suction cup. In some examples, the robotic manipulator 221, 321, 421 may be configured to exchange a first end effector for a second effector. In some cases, a controller may send instructions to the robotic manipulator 221, 321, 421 as to which end effector 222, 322, 422 to use for each different object or product (or stock keeping unit, “SKU”) being packed. Alternatively, the robotic manipulator 221, 321, 421 may determine which end effector to use based on the weight, size, shape etc. of a product. Previous successes and/or failures to grasp and move an item may be used to update the selection of an end effector for a particular SKU. This information may be fed back to the controller so that the success/failure information can be stored and shared between different picking/packing stations.

The robotic system 200 in the examples shown in FIGS. 2A and 2B includes a camera 216 mounted on the robotic manipulator 221. For example, the camera 216 is mounted at an “elbow” or “shoulder” of the robotic arm 220. In other examples, the camera 216 is supported by a structure, e.g. a frame or scaffold, on which the camera 216 is mounted.

The camera 216 is arranged to capture image data, e.g. an image, of a scene including the end effector 222 of the robotic manipulator 221. For example, the camera 216 is arranged such that it has a view of the workspace of the robotic manipulator 221, e.g. following picking and/or placement of an object by the robotic manipulator 221 (from or into a container 244, for example).

In examples, the camera 216 is configured for use in an automated pick-and-place process in which the robotic manipulator 221, 321 is controlled to pick-and-place objects, e.g. between selected containers 244, 344, based on images captured by the camera 216.

The camera 216 may correspond to the one or more cameras or imagers 116 in the sensor subsystem 114 of the robotic packing system 100 described with reference to FIG. 1. As described, the camera 216 of the robotic packing system 200 is configured to capture images. For example, an image includes visual information of the scene viewed by the camera 216.

In some examples, the camera 216 may also have depth imaging capabilities. For example, a depth camera, also known as an RGB-D camera or a “range camera”, may generate depth information (e.g. in addition to visual information) using techniques such as time-of-flight, LIDAR, interferometry, and stereo triangulation, by illuminating the scene with “structured light” or an infrared speckle pattern. In such cases, the present systems and methods may involve obtaining and processing the visual information, e.g. image data, captured by the depth camera 216. For example, in a depth camera, both colour and depth channels may be captured simultaneously, and the inspection of the end effector 222 involves obtaining and processing the colour channel data.

The robotic system 200, 300 may also include additional cameras 226, 326. For example, in the examples of FIGS. 2B and 3, the system 200, 300 includes a second camera 226, 326 mounted on, or near to, the end effector 222, 322, e.g. on or near the “wrist” of the robotic arm. Such a wrist camera 226, 326 may enable the robotic manipulator 221, 321 to “see” the surroundings of the end effector 222, 322, e.g. helping it identify objects or features in the environment. For example, vision systems may analyse the images captured by the wrist camera 226, 326 to recognize and classify objects, allowing the robot 221, 321 to interact intelligently with its surroundings. The wrist camera 226, 326 also provides feedback for hand-eye coordination of the robot 221, 321, allowing it to precisely position and manipulate objects in its workspace. For example, the wrist camera 226, 326 helps the robot 221, 321 locate objects (e.g. stored in a container 244, 344a) with higher precision, facilitating accurate pick-and-place operations. Furthermore, by continuously monitoring the surroundings of the end effector 222, 322, the wrist camera 226, 326 can help the robot 221, 321 avoid collisions with obstacles or other objects in the environment.

### Control System

A control system for the robotic manipulator 221, 321, 421, e.g. the control system 108 communicatively coupled to the manipulator apparatus of previous examples, is configured to obtain image data representative of an image of the end effector 222, 322, 422 captured by a camera 216 after a pick-and-place operation by the robotic manipulator. In some examples, multiple images of the end effector are obtained as the image data. For example, the image data may correspond to one or more video frames captured by a video camera.

The image data is processed with a neural network to determine whether the end effector is contaminated. For example, the neural network is configured to recognise a contaminated end effector in the image data based on prior training with images of contaminated end effectors. A determination that the end effector is contaminated may thus correspond to the neural network recognising the contaminated end effector with a probability score above a predetermined threshold.

In other examples, the neural network is configured to perform feature extraction on the image for comparison with one or more reference images of the end effector. Feature extraction involves extracting features from an image, e.g. raw image data. Such features can include one or more of: colour histograms (describing the distribution of colours in an image), texture patterns (capturing repeated structures or variations in local pixel values), edges or corners (representing changes in intensity or colour in an image), shape descriptors (representing the geometry or contours of objects), or local descriptors (involving extracting information from specific regions of interest, such as Scale-Invariant Feature Transform, SIFT, or Speeded-Up Robust Features, SURF). In such examples, the determination that the end effector is contaminated corresponds to the comparison with the one or more reference images returning a similarity score having a predetermined relationship with a threshold. For example, if the reference images are of uncontaminated end effectors, and the similarity score is below the set threshold, the end effector in the captured image is determined to be contaminated. Else, if the similarity score is at or above the similarity threshold, the end effector is determined to be uncontaminated.

The control system is configured to generate, in response to a determination that the end effector is contaminated, a signal indicative of the end effector being in a contaminated state. For example, the contaminated state is a defined state for an end effector representative of the end effector being contaminated, e.g. with a substance that is present on the end effector. For example, where the robotic manipulator is employed to manipulate grocery items, a contaminated end effector may have foodstuff thereon after a pick-and-place operation of a given grocery item, e.g. if the packaging of the item is damaged and the foodstuff leaks out from the packaging onto the end effector. Other industrial applications of the robotic manipulator may also lead to contamination of the end effector, e.g. by the objects being directly manipulated by the robot or by its operating environment. Examples of contamination include: fine particles, dust, or debris present in the environment or from the materials being handled by the robot such as powders (which can settle and accumulate on the gripper surfaces over time); residues (such as oil or grease from machinery, lubricants, or other sources can transfer to the gripper during operations); liquid spills (such as water, oils, or chemicals in the environment of the robot, e.g. at the picking or placement locations); adhesive substances (e.g. from labels, tapes, or packaging materials, which may transfer onto the gripper surfaces.

In some examples, the control system outputs a control signal configured to control the robotic manipulator based on the generated signal indicative of the contaminated state of the end effector. For example, the control signal may pause motion of the robotic manipulator or position it in a predetermined pose (e.g. a “home position”) to interrupt the sequence of pick-and-place operations. Manual cleaning of the end effector can then be instigated with the robot paused. For example, the generated signal indicative of the end effector being contaminated may be outputted by the output subsystem 128, e.g. via one or more output devices, such as speakers, lights, or displays to send the signal into the workspace of the robot to communicate with, for example, an operator. The operator can then have the affected robot, specifically its end effector, cleaned to decontaminate the end effector. Alternatively, the control signal may cause the robotic manipulator, specifically its end effector, to interact with a cleaning surface, e.g. as part of an automatic cleaning process.

In examples, the control system triggers, in response to the signal indicative of a contaminated end effector, a cleaning sequence to clean the contaminated end effector. For example, the cleaning sequence involves a decontamination tote (or “wash tote”), for cleaning the end effector, being delivered to the robotic manipulator. For example, the decontamination tote has a cleaning element (e.g. at least one of a sponge element, brush element, or cleaning agent) for cleaning a contaminated end effector, e.g. to remove a contaminant from the surface of the end effector. In some examples, the decontamination tote includes an ultrasonic cleaning device, e.g. an ultrasonic bath containing water or cleaning solution, into which the contaminated end effector can be at least partially submerged for cleaning by ultrasonic sound waves. In examples where the robotic manipulator is implemented in a storage system, the decontamination tote may be delivered by a load handling device (or AGV/AMR) of the storage system. For example, in the ASRS 500 of FIG. 5A, the decontamination tote is stored in the ASRS and delivered to the robotic manipulator (e.g. located at a pick station on the grid 515) by a retrieval robot 530. The cleaning sequence further involves controlling the robotic manipulator, e.g. by the present control system, to interact with the decontamination tote to clean the end effector. For example, one or more control signals are sent to the robotic manipulator to move the end effector into the decontamination tote and interact with the cleaning element(s), such as contacting the sponge/brush element or cleaning agent to remove any contaminant on the end effector.

The contamination check by the present control system can also be performed again after cleaning the end effector to determine whether the end effector is still contaminated. In response to a determination that the end effector is not contaminated, e.g. based on a captured image of the end effector after the cleaning, the robotic manipulator can proceed with further pick-and-place operations.

In some examples, a different signal is generated if the contamination check returns a negative result for contamination. For example, a second signal, indicative of the end effector being in an uncontaminated state, is generated in response to a determination, based on the image data, that the end effector is not contaminated. The control signal may trigger, in response to the second signal, the next pick-and-place operation for the robotic manipulator. For example, if the contamination check between pick-and-place operations is clear, e.g. there is no detected contamination, the control system may cause the robotic manipulator to continue in its sequence of pick-and-place operations. In the alternative, e.g. where there is detected contamination, the sequence of pick-and-place operations is interrupted so that the end effector may be cleaned of the contamination or replaced with at least part of a replacement end effector-as described in previous examples.

As described in previous examples, the control system may trigger, in response to the signal indicative of a contaminated end effector, a tool exchange at the robotic manipulator. For example, where the robotic manipulator is implemented in a storage system, a tool exchange mechanism (or “tool changer”) may be delivered by a load handling device (or AGV/AMR) of the storage system, e.g. by a retrieval robot 530 of the described ASRS 500. An automated tool exchange further involves controlling the robotic manipulator, e.g. by the present control system, to interact with the tool changer to exchange the end effector for another one. For example, one or more control signals are sent to the robotic manipulator to release the contaminated end effector and connect to another end effector.

In some examples, as shown in FIGS. 2B and 3, a second camera 226, 326 is mounted on the robotic manipulator 221, 321 toward a distal end of the robotic manipulator relative to the first camera 216 (not shown in FIG. 3). The second camera is mounted as a wrist camera for the robotic manipulator, for example, to provide visual feedback during pick-and-place operations. The present control system may cause, in response to the signal indicative of the end effector 222, 322 being contaminated, the second camera to capture an image of a pick-and-place environment of the robotic manipulator 221, 321. For example, the image may include one or more other objects, (e.g. totes 244, 344a, 344b) in the pick-and-place environment which may also be contaminated with the same or a different contaminant as the end effector 222, 322. The control system may thus cause a retrieval robot (or AGV/AMR, depending on the system implementation, such as an ASRS or other storage system) to remove the other contaminated objects from the pick-and-place environment of the robotic manipulator 221, 321 (e.g. a picking station of the storage system). A determination as to whether the one or more objects in the environment are contaminated may be made in a similar way to that described in respect of the end effector 222, 322. For example, the image of the environment captured by the second camera 226, 326 may be processed by a neural network to determine whether one or more objects in the scene are contaminated. The control system causing the retrieval robot to remove the one or more contaminated objects may therefore be done in response to a positive determination, for example.

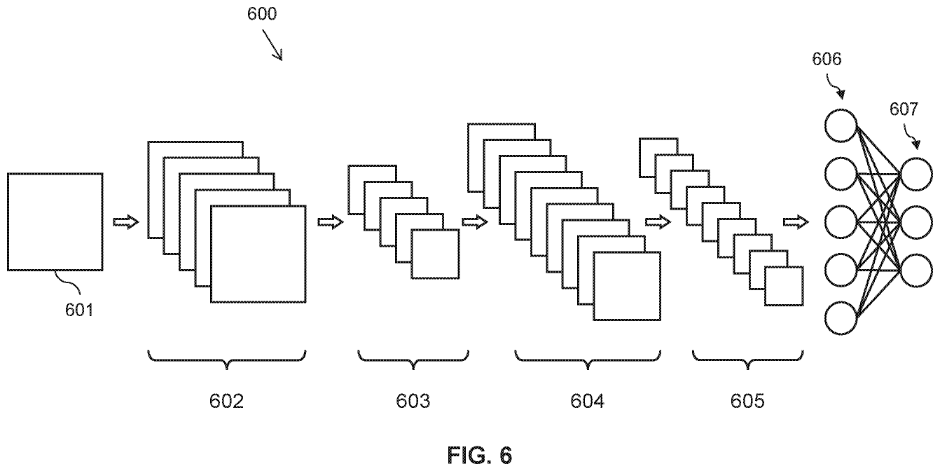

FIG. 6 shows an example of a neural network architecture. The example neural network 600 is a convolutional neural network (CNN). Example CNN architectures include UNet, VGGNet (VGG-16, VGG-19) and ResNet. An input 601 to the CNN 600 comprises image data in this example. The input image data 601 is a given number of pixels wide and a given number of pixels high and includes one or more colour channels (e.g. red, green and blue colour channels).

Convolutional layers 602, 604 of the CNN 600 typically extract particular features from the input data 601, to create feature maps, and may operate on small portions of an image. Fully connected layers 606 use the feature maps to determine an output 607, e.g. classification data specifying a class of objects predicted to be present in the input image 601.

In the example of FIG. 6, the output of the first convolutional layer 602 undergoes pooling at a pooling layer 603 before being input to the second convolutional layer 604. Pooling, for example, allows values for a region of an image or a feature map to be aggregated or combined, e.g. by taking the highest value within a region. For example, with 2×2 max pooling, the highest value of the output of the first convolutional layer 602 within a 2×2 pixel patch of the feature map output from the first convolutional layer 602 is used as the input to the second convolutional layer 604, rather than transferring the entire output. Thus, pooling can reduce the amount of computation for subsequent layers of the neural network 600. The effect of pooling is shown schematically in FIG. 6 as a reduction in size of the frames in the relevant layers. Further pooling is performed between the second convolutional layer 604 and the fully connected layer 606 at a second pooling layer 605. It is to be appreciated that the schematic representation of the neural network 600 in FIG. 6 has been greatly simplified for ease of illustration; typical neural networks may be significantly more complex.

In general, neural networks such as the neural network 600 of FIG. 6 may undergo what is referred to as a “training phase”, in which the neural network is trained for a particular purpose. A neural network (or “artificial neural network”, ANN) typically includes layers of interconnected artificial neurons forming a directed, weighted graph in which vertices (corresponding to neurons) or edges (corresponding to connections) of the graph are associated with weights, respectively. The weights may be adjusted throughout training, altering the output of individual neurons and hence of the neural network as a whole. In a CNN, a fully connected layer 606 typically connects every neuron in one layer to every neuron in another layer, and may therefore be used to identify overall characteristics of an image, such as whether the image includes an object of a particular class, or a particular instance belonging to the particular class.

In the present context, the neural network 600 is trained to perform feature extraction (for anomaly detection) and/or image classification to determine whether an image includes an instance of a contaminated end effector. Training the neural network 600 in this way for example generates weight data representative of weights to be applied to image data (for example with different weights being associated with different respective layers of a multi-layer neural network architecture). Each of these weights is multiplied by a corresponding pixel value of an image patch, for example, to convolve a kernel of weights with the image patch.

Specific to the context of gripper contamination detection, the neural network 600 may be trained with a training set of input images of grippers that are contaminated and reference images of grippers that are uncontaminated in order to detect a contaminated gripper in a given image of a gripper. For example, a set of pick images showing grippers may be annotated with labels categorising the respective gripper in a given image as uncontaminated (e.g. “clean”) or contaminated (e.g. “dirty”) to form the training set of images. Additionally, or alternatively, a picking station teleoperator may report a contaminated gripper when its picking station signals for assistance, such that an image of the contaminated gripper is captured to add to the training set of images containing contaminated grippers. In examples, the training of the neural network 600 involves using synthetically generated sample images to reduce dataset imbalance, e.g. having more clean gripper samples than uncontaminated gripper ones. Once trained, the neural network 600 can be used to detect the contamination on a gripper in captured images of a gripper, as described in examples.

Returning to examples where the robotic manipulator 221, 321, 421 is located at a picking station of a storage system, e.g. an ASRS 500, the control system may cause load handling devices 530 (or AGVs/AMRs) of the storage system to divert containers from the picking station in response to the signal indicative of the end effector being in a contaminated state. For example, any load-handling device scheduled to deliver a container to the picking station at which the contaminated end effector is located, is diverted to another picking station of the storage system. The pick-and-place operations scheduled by the master controller, e.g. a warehouse control system (WCS), involving the container are updated to be performed by the robotic manipulator at the other picking station of the storage system.

As described in examples, the image of the end effector 222 for determining contamination is captured by the camera 216—and associated image data processed by the control system—after a pick-and-place operation by the robotic manipulator. This image capture and processing may be done routinely between pick-and-place operations, e.g. where the camera is capturing a stream of images or a video feed as part of the normal operation of the robotic manipulator. In other cases, the image data is obtained by the control system for processing in response to a force feedback measurement at the end effector 222 exceeding a predetermined threshold associated with the pick-and-place operation. For example, the contamination check is done automatically in response to an irregularly high force measurement at the end effector 222 (e.g. for the particular object type being manipulated), which may be indicative of damage being done to the object so as to potentially cause contamination of the end effector.

### Control Method

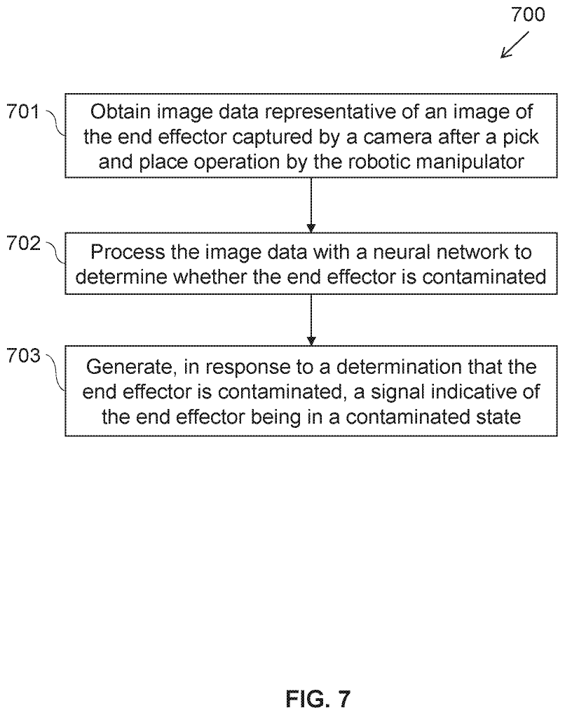

FIG. 7 shows a computer-implemented method 700 for detecting contamination on an end effector of a robotic manipulator arranged to manipulate items. The robotic manipulator may be one of the example robotic manipulators 121, 221, 321, 421 described with reference to FIGS. 1 to 4. The method 700 may be performed by one or more components of the robotic system 100 previously described, for example the control system 108 or controller 110.

At 701, image data, representative of an image of the end effector captured by a camera after a pick-and-place operation by the robotic manipulator, is obtained. The image is captured by a camera with a view of the end effector, for example the camera is mounted on the robotic manipulator.

At 702, the method involves processing the image data with a neural network (e.g. a CNN as described with reference to FIG. 6) to determine whether the end effector is contaminated. For example, the neural network is a classifier that has been trained to classify the image as containing a contaminated end effector or not. A determination that the end effector is contaminated may thus correspond to the neural network classifying the image as containing a contaminated end effector with a probability score at or above a predetermined threshold.

Alternatively, the neural network is configured for feature extraction in the image data, e.g. having been trained to automatically learn hierarchical features through its convolutional layers to capture patterns, ranging from simple edges and textures to complex object structures, in the input data. For example, as described with reference to FIG. 6, the convolutional layers of a CNN apply filters to the input, e.g. to extract low-level features in the image. Subsequent layers of the CNN may capture increasingly abstract and high-level features, enabling the network to understand spatial hierarchies.

In some examples, the input image data is modified, e.g. restricted or cropped, to frame an area of the image where the end effector is expected to be based on a model (e.g. CAD model) of the end effector. Additionally, or alternatively, the input image data may be aggregated over various viewpoints of the end effector, e.g. by rotating or otherwise moving the end effector in front of the camera.

Determining whether the end effector in the image is contaminated may be based on an anomaly score calculation and thresholding. For example, an instance with a calculated anomaly score above a threshold is flagged as an anomaly, i.e. indicative of a contaminated end effector. The anomaly score may be calculated based on various methods, e.g. a reconstruction-based method in which a difference between the input image and its reconstructed version is calculated as a reconstruction error: higher reconstruction errors indicate the presence of anomalies. Other examples for anomaly score calculation include: probabilistic models, where anomalies can be identified by assessing how likely a given data point (i.e. image) is under the learned probability distribution, with lower probabilities (e.g. below a given threshold) indicative of anomalies; and out-of-distribution (OOD) methods such as measuring a Mahalanobis distance of a data point in the feature space from the distribution of normal data, wherein a larger Mahalanobis distance (e.g. above a given threshold) is indicative of an anomaly. Other examples of OOD methods include using a Kullback-Leibler divergence, involving measuring the difference between the predicted distribution and a reference distribution wherein a high divergence can indicate an anomaly sample, and the similar Jensen-Shannon divergence.

At 703, in response to a determination that the end effector is contaminated, a signal indicative of the end effector being in a contaminated state is generated. For example, the generated signal is outputted by one or more output devices (e.g. speakers, lights, or displays). Other automatic systems, or a human operative, can then respond to the signal to resolve the contamination, e.g. by cleaning or replacing the contaminated end effector.

In some examples, the method involves outputting a control signal configured to control the robotic manipulator based on the generated signal. For example, the control signal may pause motion of the robotic manipulator or position it in a predetermined pose (e.g. a “home position”) to interrupt the sequence of pick-and-place operations. Manual cleaning of the end effector can then be instigated with the robot paused. Alternatively, the, or a further, control signal may cause the robotic manipulator, specifically its end effector, to interact with a cleaning surface, e.g. as part of an automatic cleaning process, as described in examples. The method may involve causing a decontamination tote, for cleaning the contaminated end effector, to be delivered to the robotic manipulator prior to controlling the robotic manipulator to interact with the decontamination tote to clean the end effector. For example, the decontamination tote has at least one of a sponge element, brush element, or cleaning agent for cleaning the end effector of contaminants.

As described, when a positive determination of a contaminated end effector is made based on the image processing 702, the pick-and-place operations at the robotic manipulator are interrupted or paused, e.g. to allow for cleaning or replacement of the end effector before resuming operation. In some examples, where the processing 702 leads to a negative determination of a contaminated end effector, e.g. where the anomaly detection returns no anomaly, a different signal—indicative of the end effector being in an uncontaminated state—is generated as part of the method 700. For example, this different signal allows for the pick-and-place operations at the robotic manipulator to continue (or resumed in the case that the operations were previously paused due to detected contamination). The next pick-and-place operation scheduled for the robotic manipulator is triggered in response to the different signal, for example.

The contamination detection method 700, or at least the image processing to determine whether the imaged end effector is contaminated, may be triggered based on force feedback at the end effector. For example, a detected force at the end effector that is outside an expected range, e.g. for a given object being manipulated thereby, may trigger the obtaining and/or processing of the image data.

The method 700 described in examples can be implemented by a control system, e.g. one or more controllers, for a robotic manipulator, e.g. the control system previously described. For example, the control system includes one or more processors to carry out the method 700 in accordance with instructions, e.g. a program including computer-readable instruction, a.k.a., computer program code, stored on a computer-readable data carrier or storage medium.

The above examples are to be understood as illustrative. Further examples are envisaged. For instance, the neural network for processing the image data has been described in examples as a CNN, e.g. with reference to FIG. 6. However, in other examples, the (artificial) neural network may comprise a Vision Transformer (ViT) architecture, e.g. for image classification. The ViT approach applies a Transformer architecture, originally developed for natural language processing tasks, to the image data.

Alternatively, the (artificial) neural network may be an autoencoder comprising an encoder that compresses the input into a lower-dimensional space and a decoder that reconstructs the input from this representation. The anomaly detection using such an autoencoder is based on the neural network reconstructing normal instances, wherein anomalies result in higher reconstruction errors, indicating deviations from the learned normal patterns. As a further example, the neural network comprising a Variational Autoencoder (VAE) extends the autoencoder with probabilistic modelling, e.g. to model the latent space with probability distributions, providing a more nuanced understanding of normal data variability. The VAE may detect anomalies (i.e. contamination) by observing deviations from the expected distribution in the latent space: unusual patterns lead to representations that are less likely under the modelled distribution.

The predetermined threshold for classification (probability) scores or anomaly scores to determine a positive contamination detection in the examples above may also be dynamic instead of a constant in envisaged examples. For example, such a threshold may depend on the item picked-and-placed by the robot prior to the contamination check: a SKU with a higher risk of contamination or of a special type such as raw meat, chemicals, etc., may be associated with a lower threshold for determining a positive result in the contamination check compared to other SKUs.

In another envisaged example, the contamination check may have two stages. For example, a single image of the end effector is obtained and processed with the neural network as an initial check, which if it fails, causes one or more further images to be obtained for a more detailed check. The one or more further images of the end effector may be captured in response to the failed initial check.

What is claimed is:

1. A method for detecting contamination on an end effector of a robotic manipulator arranged to manipulate items, the method comprising:
obtaining image data representative of an image of the end effector captured by a camera after a pick-and-place operation by the robotic manipulator;
processing the image data with a neural network to determine whether the end effector is contaminated; and
generating, in response to a determination that the end effector is contaminated, a signal indicative of the end effector being in a contaminated state.

2. The method according to claim 1, comprising obtaining the image data in response to a force feedback measurement at the end effector exceeding a predetermined threshold associated with the pick-and-place operation.

3. The method according to claim 1, wherein the neural network is configured to recognise a contaminated end effector in the image data based on prior training with images of contaminated end effectors.

4. The method according to claim 3, wherein the determination that the end effector is contaminated corresponds to the neural network recognising the contaminated end effector with a probability score above a predetermined threshold.

5. The method according to claim 1, wherein the neural network is configured to perform feature extraction on the image for comparison with one or more reference images of the end effector.

6. The method according to claim 5, wherein the determination that the end effector is contaminated corresponds to a comparison with the one or more reference images returning a similarity score having a predetermined relationship with a threshold.

7. The method according to claim 1, comprising triggering, in response to the signal, a cleaning sequence to clean the contaminated end effector.

8. The method according to claim 7, wherein the cleaning sequence comprises:
delivering to the robotic manipulator a decontamination tote for cleaning the end effector; and
controlling the robotic manipulator to interact with the decontamination tote to clean the end effector.

9. The method according to claim 8, wherein the decontamination tote comprises at least one of a sponge element, brush element, ultrasonic cleaning device, or cleaning agent.

10. The method according to claim 1, wherein the camera is a first camera and wherein a second camera is mounted on the robotic manipulator toward a distal end of the robotic manipulator relative to the first camera, the method comprising:
causing, in response to the signal, the second camera to capture an image of a pick-and-place environment of the robotic manipulator.

11. The method according to claim 1, wherein the signal is a first signal, the method comprising:
generating, in response to determining that the end effector is not contaminated, a second signal indicative of the end effector being in an uncontaminated state.

12. The method according to claim 11, comprising triggering, in response to the second signal, the next pick-and-place operation for the robotic manipulator.

13. The method according to claim 1, comprising outputting a control signal configured to control the robotic manipulator based on the generated signal.

14. The method according to claim 1, wherein the robotic manipulator is located at a picking station of a storage system comprising a plurality of containers for storing items and a load-handling device for transporting one or more containers of the plurality of containers, the method comprising:
causing, in response to the signal indicative of the end effector being in a contaminated state, any load-handling device scheduled to deliver a container to the picking station to be diverted to another picking station of the storage system.

15. A computer program comprising instructions which, when the program is executed by a computer, cause the computer to carry out the method of claim 1.

16. A non-transitory computer-readable storage medium having stored thereon the computer program of claim 15.

17. A control system for a robotic manipulator, the control system comprising one or more controllers configured to perform the method of claim 1.

18. A pick-and-place robot system comprising the control system of claim 17 and the robotic manipulator for picking and placing an object.

19. A storage system comprising:
a plurality of containers for storing items;
a load-handling device for transporting a given container of the plurality of containers; and
the pick-and-place robot system of claim 18 arranged to pick-and-place one or more items from or into the given container.
